(19) United States
(12) Patent Application Publication
(10) Pub. No.: US 2026/0065058 A1
(43) Pub. Date: Mar. 5, 2026

(54) ELECTRONIC DEVICE AND METHOD OF TRAINING TRANSFORMER MODEL AND PERFORMING INFERENCE USING TRANSFORMER MODEL

(71) Applicant: Samsung Electronics Co., Ltd., Suwon-si (KR)

(72) Inventors: Sukju Kang, Seoul-si (KR); Beoungwoo Kang, Seoul-si (KR); Seunghun Moon, Seoul-si (KR); Hyunwoo Yu, Seoul-si (KR); Yubin Cho, Seoul-si (KR)

(73) Assignees: Samsung Electronics Co., Ltd., Suwon-si (KR); SOGANG UNIVERSITY RESEARCH & BUSINESS DEVELOPMENT FOUNDATION, Seoul (KR)

(21) Appl. No.: 19/298,694

(22) Filed: Aug. 13, 2025

(30) Foreign Application Priority Data
Aug. 28, 2024 (KR) 10-2024-0116248
Oct. 22, 2024 (KR) 10-2024-0145295

(51) Int. Cl. G06N 3/082; G06N 3/0455; G06N 3/063

(52) U.S. Cl. CPC G06N 3/082; G06N 3/0455; G06N 3/063

(57) ABSTRACT

Provided is a method of performing inference by using a transformer model including a plurality of encoders and a plurality of decoders, wherein each of the plurality of encoders and the plurality of decoders includes a transformer block including an attention block, and the method is performed by an electronic device and includes receiving input data and using the transformer model to perform inference on the input data, thereby generating output data, wherein the generating of the output data includes skipping performing a key embedding computation, a query embedding computation, and a value embedding computation on input data of the attention block.

### CROSS-REFERENCE TO RELATED APPLICATION(S)

This application is based on and claims priority under 35 U.S.C. § 119 to Korean Patent Application Nos. 10-2024-0116248, filed on Aug. 28, 2024, and 10-2024-0145295, filed on Oct. 22, 2024, in the Korean Intellectual Property Office, the disclosures of all of which are incorporated by reference herein in their entireties.

### BACKGROUND

The inventive concept relates to training a transformer model including an encoder and a decoder or to performing inference using the transformer model.

Transformer models represent models that follow encoder-decoder structures used in existing sequence-to-sequence (Seq2Seq) structures, and are designed with attention mechanisms, specifically self-attention, rather than using recurrent neural networks (RNNs) or long short-term memory (LSTM).

The transformer models are commonly used in the field of natural language processing (NLP), especially in tasks, such as translation, question and answer (Q&A), and text generation. In addition, recently, the transformer models have also been utilized in vision tasks, such as computer vision (e.g., image classification, object detection, etc.).

### SUMMARY

The inventive concept provides a method of efficiently reducing the size of a transformer model, which reduces computation quantities required to train a transformer model or perform inference by using the transformer model while maintaining performance thereof.

According to an aspect of the inventive concept, there is provided an electronic device including a processor configured to train a transformer model including a plurality of encoders and a plurality of decoders, or configured to perform inference by using a pre-trained transformer model and memory configured to store instructions executed by the processor, wherein each of the plurality of encoders includes a patch embedding block configured to perform patch embedding on input data and a first attention block configured to generate attention value data, and when the instructions are executed by the processor, the processor is configured to perform a normalization computation on patch data, which is a result by the patch embedding block, to thereby generate normalized patch data and use the normalized patch data as a query and a result of performing a spatial reduction computation on the normalized patch data as a key and a value in the first attention block, to thereby generate attention value data with respect to the patch data.

According to another aspect of the inventive concept, there is provided a method of training a transformer model including a plurality of encoders and a plurality of decoders, wherein each of the plurality of encoders and the plurality of decoders includes a transformer block including an attention block, and the method is performed by an electronic device and includes receiving target data and training data and training the transformer model to output the target data with respect to the training data, wherein the training of the transformer model includes skipping performing one or more of a key embedding computation, a query embedding computation, and a value embedding computation on input data of the attention block.

According to another aspect of the inventive concept, there is provided a method of performing inference by using a transformer model including a plurality of encoders and a plurality of decoders, wherein each of the plurality of encoders and the plurality of decoders includes a transformer block including an attention block, and the method is performed by an electronic device and includes receiving input data and using the transformer model to perform inference on the input data, thereby generating output data, wherein the method further includes skipping performing one or more of a key embedding computation, a query embedding computation, and a value embedding computation on input data of the attention block.

### BRIEF DESCRIPTION OF THE DRAWINGS

Embodiments will be more clearly understood from the following detailed description taken in conjunction with the accompanying drawings in which:

FIG. 1 is a block diagram illustrating an electronic device that trains a transformer model or performs inference by using the transformer model, according to an example embodiment;

FIG. 2 is a diagram illustrating a structure of a transformer model, according to an example embodiment;

FIG. 3 is a diagram illustrating a structure of a transformer block, according to an example embodiment;

FIG. 4 is a diagram illustrating a processing operation in an attention block, according to an example embodiment;

FIG. 5 is a diagram illustrating a structure of a transformer block, according to an example embodiment;

FIG. 6 is a diagram illustrating a processing operation in an attention block of an encoder, according to an example embodiment;

FIG. 7 is a diagram illustrating a processing operation in an attention block of a decoder, according to an example embodiment;

FIG. 8 is a diagram illustrating training and inference of the transformer model described with reference to FIG. 5;

FIG. 9 is a diagram illustrating the computation quantity and performance evaluation of the transformer model of FIG. 5 according to a reduction ratio applied during training and a reduction ratio applied during inference;

FIG. 10 is a diagram illustrating the computation quantity and performance evaluation of the transformer model of FIG. 5;

FIG. 11 is a flowchart illustrating operations in a method of training the transformer model of FIG. 3;

FIG. 12 is a flowchart illustrating an operation of any one attention block in the transformer model in operation S1120 of FIG. 11;

FIG. 13 is a flowchart illustrating operations in a method of performing inference by using the transformer model of FIG. 3; and

FIG. 14 is a flowchart illustrating an operation of any one attention block in a pre-trained transformer model in operation S1320 of FIG. 13.

### DETAILED DESCRIPTION OF THE EMBODIMENTS

Hereinafter, embodiments are described clearly and in detail so that a person skilled in the art can easily practice the inventive concept. Like reference characters refer to like elements throughout.

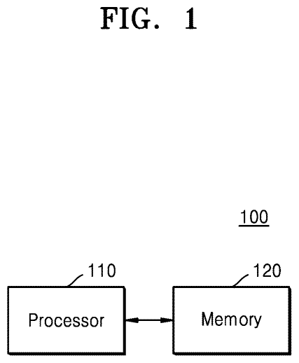

FIG. 1 is a block diagram illustrating an electronic device that trains a transformer model or performs inference by using the transformer model, according to an example embodiment.

Referring to FIG. 1, an electronic device 100 includes a device that trains a transformer model to output target data, or generates result data by performing inference by using a transformer model having been pre-trained for given input data. The electronic device 100 according to various embodiments may include various types of devices. The electronic device 100 may include, for example, a portable communication device (e.g., a smartphone), a computer device, a portable multimedia device, a portable medical device, a camera, a wearable device, a consumer electronic device, or a server. The electronic device 100 according to example embodiments is not limited to the devices described above.

The electronic device 100 may include a processor 110 and memory 120. The processor 110 may, for example, execute software to control one or more other components of the electronic device 100 (e.g., hardware or software components) connected to the processor 110 and may perform various data processing or computation. According to an embodiment, as at least part of data processing or computation, the processor 110 may store instructions or data in the memory 120, process the instructions or data stored in the memory 120, and store the result data in the memory 120. According to an embodiment, the processor 110 may include a main processor (e.g., a central processing unit or an application processor) or a coprocessor (e.g., a graphics processing unit, a neural processing unit (NPU), an image signal processor (ISP), a sensor hub processor, or a communication processor) that may operate independently of or in conjunction with the main processor.

The memory 120 may store instructions executed by one or more components (e.g., the processor 110) of the electronic device 100 and various pieces of data used by the one or more components. The data may include, for example, software (e.g., a computer-executable program), input data or output data for instructions related to the software, and data about a transformer model. The memory 120 may include volatile memory, such as random access memory (RAM), dynamic random-access memory (DRAM), and static random-access memory (SRAM), and/or non-volatile memory, such as flash memory.

The processor 110 may control all operations of the electronic device 100 and may perform one or more of the operations described herein.

In an embodiment, the processor 110 may train a transformer model such that the transformer model outputs target data for a given input. Here, the transformer model may include a plurality of encoders, a plurality of decoders, and at least one multilayer perceptron (MLP). For example, during training of the transformer model, the processor 110 may continuously change parameters (e.g., weights) included in the MLP to output the target data for the given input. Also, after the training is complete, the processor 110 may perform inference by using the transformer model. However, the embodiment is not limited thereto, and even after the training is complete, the processor 110 may further train the transformer model while performing the inference process.

Each of the encoders and the decoders in the transformer model may include an attention block for determining an attention value. Here, the attention may include self-attention that is performed on oneself. The attention value may represent a probability value that a specific element in the input data is associated with another element in the input data.

For example, in the case of natural language processing (NLP), the input data may include sentence data representing sentences. When the input data includes sentence data representing sentences, the attention value may represent a probability value that a specific word in the input sentence is associated with another word in the input sentence. The self-attention represents determining similarity between words in the input sentence as an attention value, and the attention value derived through the self-attention may represent the degree of relevance of each word to other words.

In addition, in the case of image processing, the input data may include a plurality of pieces of patch data representing an image. When the transformer model is applied to image processing, the image data may be divided into several pieces of patch data (e.g., pieces of 16×16 pixel size) and used as input data. Here, each piece of patch data may have a similar function to a word in the input sentence. The attention value may represent a probability value that the input patch data of the image data is associated with other patch data of the image data. The self-attention represents determining similarity between pieces of input patch data as an attention value, and the attention value derived through the self-attention may represent the degree of relevance of each piece of patch data to other pieces of patch data in the same image data.

Although the input data of the transformer model is described herein as a plurality of pieces of patch data as an example of image processing, the embodiments are not limited thereto.

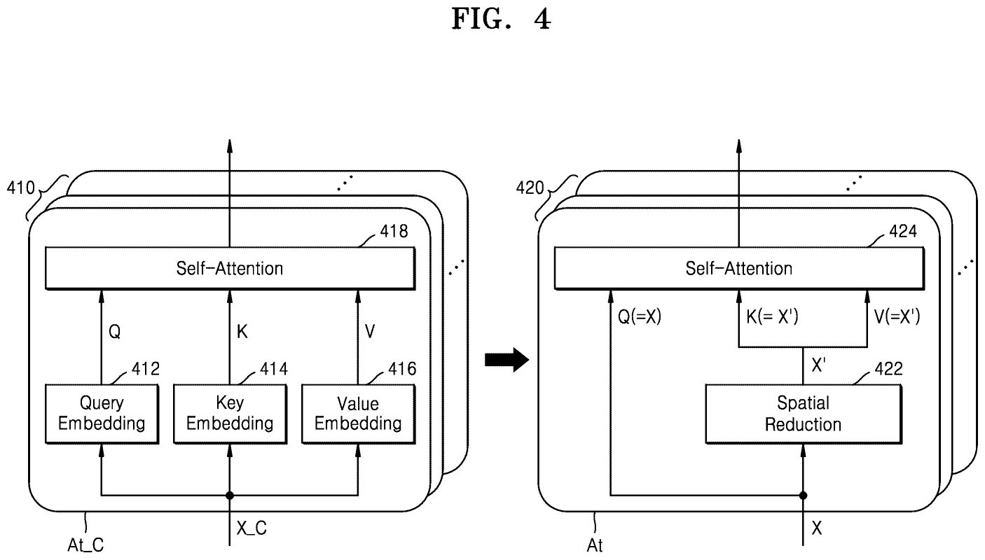

According to the inventive concept, in attention blocks At illustrated in FIG. 4, the operations of a query embedding block 412 in a comparative example, a key embedding block 414 in a comparative example, and a value embedding block 416 in a comparative example on data λ input to an attention block At are skipped. Accordingly, the computation quantities in the query embedding block 412, the key embedding block 414, and the value embedding block 416 may be reduced, and thus, the computation complexity may be reduced.

Furthermore, according to the inventive concept, in the attention block At illustrated in FIG. 4, original data being input to the attention block At is used for query, and spatially reduced data is replaced for key and value. Accordingly, attention computation may be performed on important information while further reducing the computation complexity.

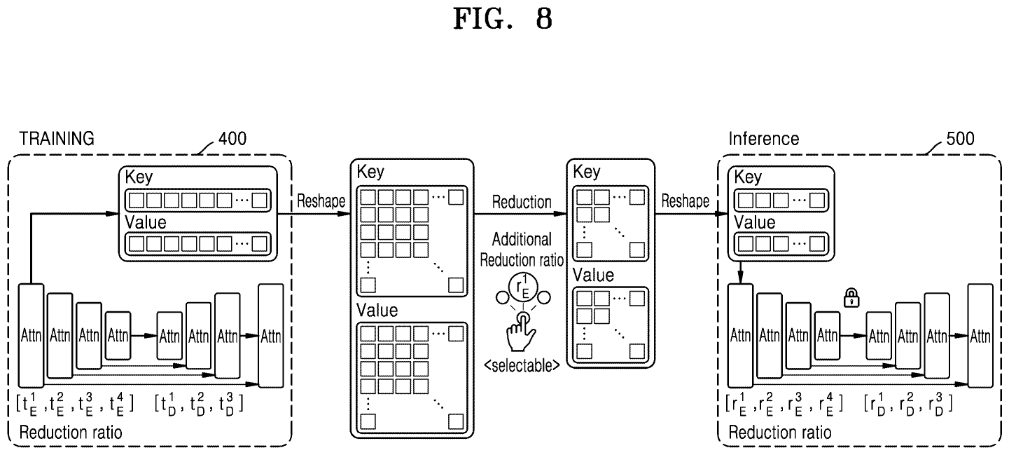

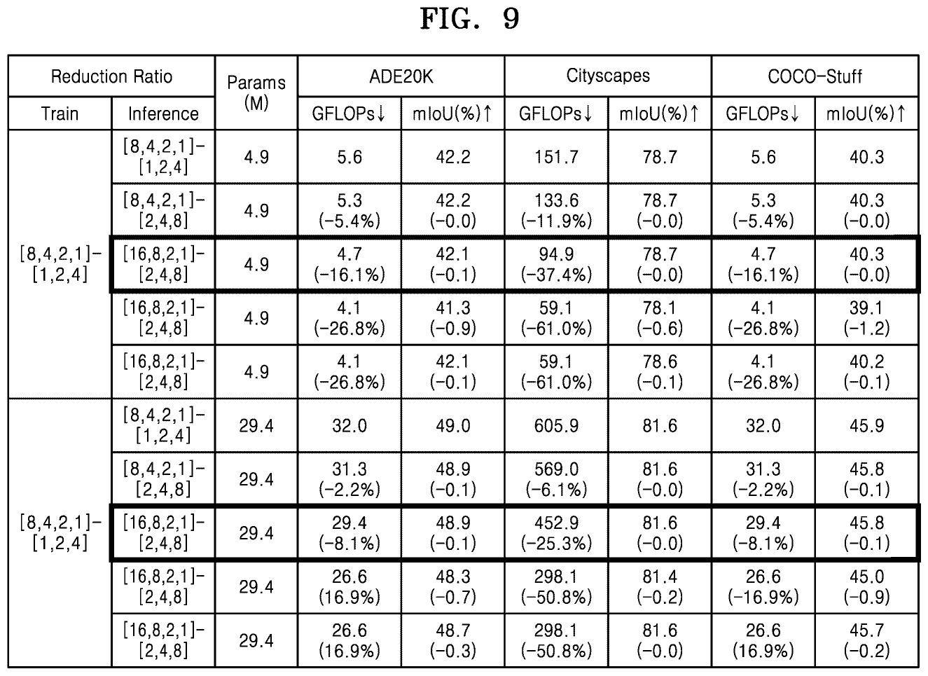

Also, as described below with reference to FIGS. 8 and 9, some of reduction rates applied to a spatial reduction computation for each transformer block in a transformer model 500 that has been pre-trained (or referred to as a pre-trained transformer model 500) may be greater than a corresponding reduction ratio in a transformer model 400 that is being trained (or referred to as a training transformer model 500). Accordingly, when performing inference of the pre-trained transformer model 500, the computation complexity may be further reduced.

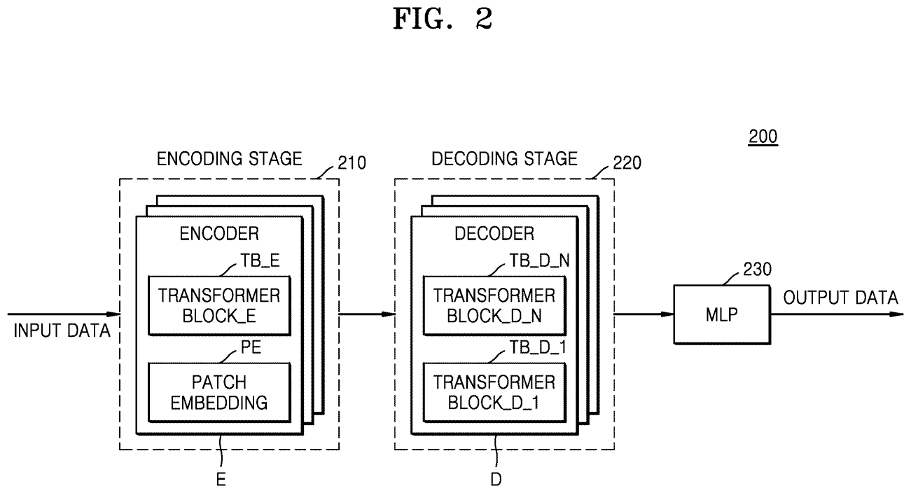

In some embodiments, the transformer models 200, 300, 400, and 500 below may be performed by the electronic device 100. For example, each of the blocks illustrated in FIGS. 2 to 8 may correspond to hardware, software, or a combination of hardware and software in the electronic device 100. The hardware may include at least one of programmable components, such as a central processing unit (CPU), a digital signal processor (DSP), and a graphics processing unit (GPU), reconfigurable components, such as a field programmable gate array (FPGA), and components, such as intellectual property (IP) blocks, that provide fixed functionality. The software may include at least one of a series of instructions executable by the programmable components and code convertible to the series of instructions by a compiler or the like, and may be stored on a non-transitory storage medium.

FIG. 2 is a diagram illustrating a structure of a transformer model according to an example embodiment.

Referring to FIG. 2, the transformer model 200 may be trained to output target output data OUTPUT DATA with respect to given input data INPUT DATA. Alternatively, the transformer model 200 may perform inference on given input data INPUT DATA and provide output data OUTPUT DATA.

Referring to FIG. 2, the transformer model 200 may include a plurality of encoders 210, a plurality of decoders 220, and an MLP 230. Here, the plurality of encoders 210 may be referred to as an encoding stage, and the plurality of decoders 220 may be referred to as a decoding stage.

The plurality of encoders 210 may process input data INPUT DATA and provide processed data to the plurality of decoders 220. Here, in this example, the input data INPUT DATA may include image data and represent an RGB value for each pixel.

The plurality of decoders 220 may process the data received from the plurality of encoders 210 and provide the processed data to the MLP 230.

The MLP 230 may process the data received from the plurality of decoders 220 and output output data OUPUT DATA. Here, the output data OUTPUT DATA may include data predicted in units of pixels. For example, the output data OUPUT DATA may include a probability value for which each pixel belongs to, such as “sky”, “road”, “vehicle”, or “pedestrian,” in an image segmentation task.

Each of the plurality of encoders 210 may include a patch embedding block PE and a transformer block TB_E. Referring to FIG. 2, an encoder E in the plurality of encoders 210 may include the patch embedding block PE and the transformer block TB_E. Here, the plurality of encoders 210 may be hierarchically connected to each other. For example, a previous encoder may provide an execution result of the previous encoder to a next encoder. In example embodiments, an execution result of a first encoder of the plurality of encoders 210 may be provided to a second encoder of the plurality of encoders 210, and an execution result of the second encoder of the plurality of encoders 210 may be provided to a third encoder of the plurality of encoders 210, and so until the last encoder of the plurality of encoders 210.

The patch embedding block PE may perform patch embedding, which splits data input to the patch embedding block PE into a plurality of patches and generates a plurality of patch tokens. For example, the patch embedding block PE may generate patch data by performing the patch embedding on the data that is input (or referred to as the input data) to the patch embedding block PE.

For example, when an encoder E is an encoder E located at the front end among the plurality of encoders 210 and the input data INPUT DATA is input to the encoder E, the patch embedding block PE may perform patch embedding on the input data INPUT DATA and generate patch data that is a result of the patch embedding block PE. Here, the patch data may include data in which a plurality of patch tokens have been transformed into a single vector. In addition, the patch embedding block PE may provide the generated patch data to the transformer block TB_E, which is located at the front end and included in the encoder E.

Also, for example, when an encoder E is an encoder E that is not located at the front end among the plurality of encoders 210, output data of a previous encoder may be input to the encoder E. The output data of the previous encoder may include an execution result of a transformer block of the previous encoder. The patch embedding block PE included in the encoder E not located at the front end may perform patch embedding on the execution result of the transformer block of the previous encoder, thereby generating patch data that is a result of the patch embedding block PE. In addition, the patch embedding block PE may provide the generated patch data to the transformer block TB_E, which is not located at the front end and included in the encoder E.

In embodiments, the patch embedding block PE may maintain locality of data that is input by overlapping patches of data that are input through an overlapped patch merging method. This allows for better preservation of relationships between spatially adjacent patches. Also, the patch embedding block PE is performed based on a convolution operation and may provide position information via a convolution operation instead of a positional encoding value used in an existing transformer model. This may compensate for a limitation of the existing transformer model by utilizing the characteristics of a convolution computation that trains a local pattern. That is, the patch embedding block PE may provide position information-embedded patch embedding via the convolution operation and maintain local information of the data that is input via the overlapped patch merging.

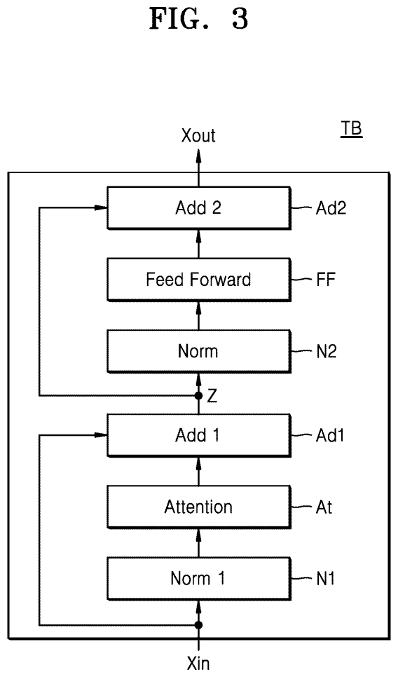

The transformer block TB_E represents a basic component of the transformer model, which may extract meaningful features by processing input data. The features of the input data may be extracted on the basis of attention value data, which is an execution result of an attention block included in the transformer block TB_E. For example, the transformer block TB_E may correspond to a transformer block TB of FIG. 3. That is, the transformer block TB shown in FIG. 3 may correspond to a transformer block TB_E included in any one encoder among the plurality of encoders 210. The transformer block TB is described in detail with reference to FIG. 3.

Each of the plurality of decoders 220 may include at least one transformer block. For example, each of the plurality of decoders 220 may include at least one transformer block corresponding to the transformer block TB illustrated in FIG. 3. Here, the transformer blocks included in the at least one transformer block may be connected to each other. That is, an execution result of a previous transformer block may be provided to a next transformer block.

Referring to FIG. 2, a decoder D in the plurality of decoders 220 may include a first transformer block TB_D_1 to an Nth transformer block TB_D_N. Here, N is an integer greater than or equal to 2. Each of the first transformer block TB_D_1 to the Nth transformer block TB_D_N represents a basic component of the transformer model, which may extract meaningful features by processing input data. The features of the input data may be extracted on the basis of attention value data, which is an execution result of an attention block included in each of the first transformer block TB_D_1 to the Nth transformer block TB_D_N. For example, each of the first transformer block TB_D_1 to the Nth transformer block TB_D_N may correspond to a transformer block TB of FIG. 3. That is, the transformer block TB shown in FIG. 3 may correspond to at least one transformer block in any one decoder among the plurality of decoders 220. The transformer block TB is described in detail with reference to FIG. 3.

Each of the plurality of decoders 220 may receive processed data from a corresponding one of the plurality of encoders 210, and generate data that is to be provided to the MLP 230.

For example, referring to FIG. 2, when the decoder D corresponds to the encoder E, the decoder D may receive data from the encoder E. The first transformer block TB_D_1 may process data provided from the encoder E and may provide the processed data to a next transformer block. Also, the Nth transformer block TB_D_N may process data provided from a previous transformer block and may generate data that is provided to the MLP 230.

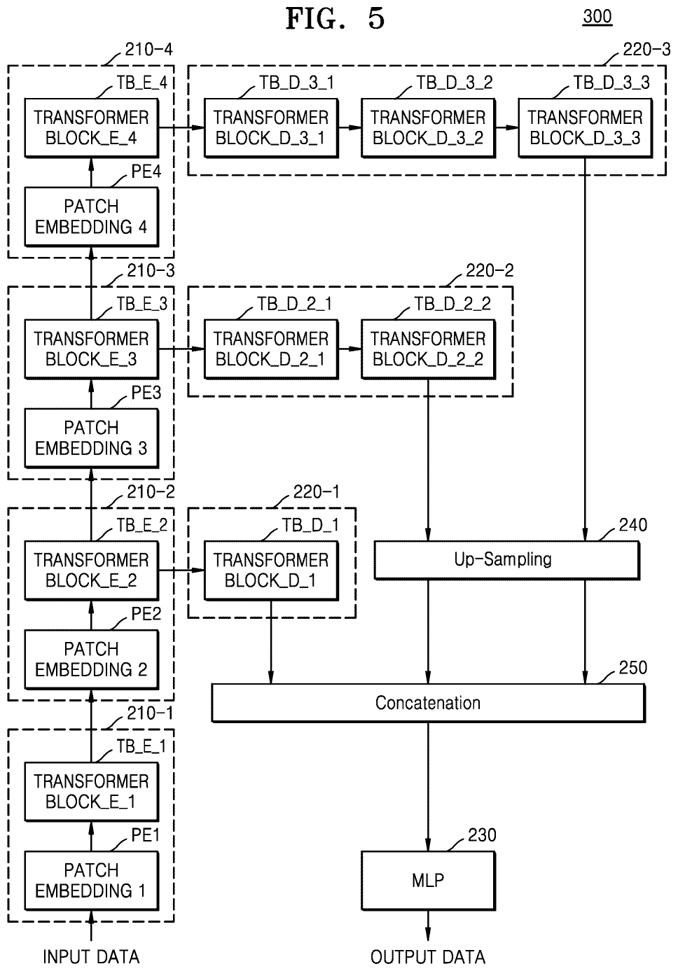

In an embodiment, the number of transformer blocks in each of the plurality of decoders 220 may vary. For example, as the number of patch embedding operations performed on data input to a first decoder among the plurality of decoders 220 increases, the number of transformer blocks in the first decoder may increase. This is described in detail with reference to FIG. 5.

FIG. 3 is a diagram illustrating a structure of a transformer block according to an example embodiment. Here, the transformer block TB may correspond to a transformer block TB_E in any one encoder among the plurality of encoders 210 shown in FIG. 2. Also, the transformer block TB may correspond to at least one transformer block in any one decoder among the plurality of decoders 220 shown in FIG. 2.

Referring to FIG. 3, the transformer block TB may include a first layer normalization block N1, a second layer normalization block N2, an attention block At, a first residual connection block Ad1, a second residual connection block Ad2, and a feed-forward network block FF. When implemented as layers of a neural network, the encoder E may include a first sublayer corresponding to an attention block At and a second sublayer corresponding to a feed-forward network block FF.

The attention block At for generating attention value data may correspond to multi-head self-attention. The multi-head self-attention may represent performing self-attention computations in parallel. The self-attention computation represents performing an attention computation on itself, and the attention computation represents processing to obtain an attention value.

The feed-forward network block FF may perform a linear transformation on input data by utilizing a weight matrix and/or a depthwise convolution (DW) computation.

In an embodiment, the feed-forward network block FF may perform the linear transformation on the input data, according to Equation 1 below.

$$FFL ( x ) = Linear ( ( DW ( Linear ( x ) ) ) \qquad [ Equation 1 ]$$

Here, x represents data that is input to the feed-forward network block FF, FFL (x) represents an execution result of the feed-forward network block FF on the input data x, Linear represents a linear transformation computation, and DW represents a DW computation.

That is, according to Equation 1, the feed-forward network block FF may perform a first linear transformation on the input data x, perform a DW computation on the execution result of the first linear transformation, and perform a second linear transformation on the result of the DW computation, thereby outputting the execution result of the linear transformation computation of the feed-forward network block FF on the input data x.

The first residual connection block Ad1 and the second residual connection block Ad2 may connect an input and an output of each of the sublayers. For example, the first residual connection block Ad1 and the second residual connection block Ad2 may perform summation (or concatenation) computations on the input and the output of each of the sublayers.

The first layer normalization block N1 and the second layer normalization block N2 may perform a normalization computation on an input of each of the sublayers. In example embodiments, the first layer normalization block N1 may normalize patch data (e.g., input data Xin received by one of the plurality of encoders 210). In another example embodiments, the first layer normalization block N1 may normalize feature data (e.g., input data Xin received by one of the plurality of encoders 210). In some embodiments, the input data Xin of FIG. 3 may correspond to the input data INPUT DATA of FIG. 2. In other embodiments, the input data Xin of FIG. 3 may correspond to an execution result output by a prior encoder of the plurality of encoders 210.

The attention block At may determine similarity with each of all keys for a given query and reflect the determined similarity as a weight to each of values mapped to the keys. The attention block At may provide, as an attention value, a weighted sum of values reflecting the similarity.

For example, when the input data INPUT DATA is input to the encoder located at the frontmost end among the plurality of encoders 210 shown in FIG. 2, the query, key, and value herein may represent all patch tokens of image data (or patch data normalized by the first layer normalization block N1). The self-attention performed by the attention block At obtains the similarity between patch tokens in the image data, and thus, the probability that a specific token is associated with another token may be determined.

The query, key, and value input to an encoder after the encoder located at the frontmost end, or to a decoder, may include feature data (or feature data normalized by the first layer normalization block N1) generated by a previous transformer block in a previous encoder, a corresponding encoder, or the same decoder.

According to the inventive concept, in the attention block At, the execution of the key embedding computation, the execution of the query embedding computation, and/or the execution of the value embedding computation on the input data of the attention block At may be skipped. This is described in detail with reference to FIG. 4.

FIG. 4 is a diagram illustrating a processing operation in an attention block, according to an example embodiment.

FIG. 4 illustrates a processing operation performed in an attention block At_C according to a comparative example and a processing operation performed in an attention block At proposed herein. The processing operation performed in the attention block At may be performed by the processor 110 of FIG. 1.

Referring to the attention block At_C in FIG. 4, in the attention block At_C according to the comparative example, attention computations are performed in parallel according to a multi-head structure 410, and computations of a query embedding block 412, a key embedding block 414, and a value embedding block 416 are performed on data X_C that is input to the attention block At_C according to the comparative example. Accordingly, a query Q, which is a result of linear transformation of input data X_C and a query weight matrix, a key K, which is a result of linear transformation of the input data X_C and a key weight matrix, and a value V, which is a result of linear transformation of the input data X and a value weight matrix, are provided to a self-attention block 418. The self-attention block 418 derives an attention weight by performing a dot product computation and a soft max computation on the query Q and the key K, and generates attention value data by performing a weighted sum computation on the attention weight and the value V.

In the proposed attention block At, the attention computations may be performed in parallel according to a multi-head structure 420. In the proposed attention block At, the computations of the query embedding block 412 according to the comparative example, the key embedding block 414 according to the comparative example, or the value embedding block 416 according to the comparative example may be skipped with respect to the data X input to the attention block At.

In addition, the proposed attention block At may further include a spatial reduction block 422. The spatial reduction block 422 may reduce spatial dimensions of the data (e.g., image data, patch tokens, patch data, or a height dimension H and a width dimension W of a feature) that is input by down-sampling. Accordingly, the attention computations may be focused only on parts that are required to maintain important feature information, while still performing the attention computations efficiently. For example, referring to proposed attention block At in FIG. 4, the spatial reduction block 422 may perform a spatial reduction computation on the data X input to the proposed attention block At, and may provide an execution result X′ of the spatial reduction computation as the key (e.g., K=(X′)) and value (e.g., V=(X′)) to the self-attention block 424.

In addition, the spatial reduction block 422 may perform, on the input data X, a spatial reduction computation having a reduction ratio R. For example, when the reduction ratio R is 2, as each of the height dimension H and the width dimension W is reduced by half, the size of the execution result data in the computation may be H/2*W/2. When the reduction ratio R is 4, as each of the height dimension H and the width dimension W is reduced by ¼, the size of the execution result data in the computation may be H/4*W/4. When the reduction ratio R is 8, as each of the height dimension H and the width dimension W is reduced by ⅛, the size of the execution result data in the computation may be H/8*W/8.

In an embodiment, the spatial reduction block 422 may correspond to a convolution-based function that performs down-sampling by the reduction ratio R.

Referring to proposed attention block At in FIG. 4, the data X input to the proposed attention block At may be provided as a query (e.g., Q=(X′)) to the self-attention block 424, and the execution result X′ of the spatial reduction computation of the spatial reduction block 422 on the data X input to the proposed attention block At may be provided as a key (e.g., K=(X′)) and a value (e.g., V=(X′)) to the self-attention block 424. The self-attention block 424 derives an attention weight by performing a dot product computation and a soft max computation on a query Q and a key K, and may generate attention value data by performing a weighted sum computation on the attention weight and a value V.

According to the inventive concept, in the proposed attention block At, the computations of the query embedding block 412 according to the comparative example, the key embedding block 414 according to the comparative example, and the value embedding block 416 according to the comparative example are skipped with respect to the data X input to the attention block At. Accordingly, the computation quantities of the query embedding block 412, the key embedding block 414, and the value embedding block 416 may be reduced, thereby reducing the computation complexity. Each of the query embedding block 412, the key embedding block 414, and the value embedding block 416 may have the computation quantity of HWC2, and thus, the total computation quantities may be reduced by 3HWC2. Here, H may represent a vertical size of the input data X, W may represent a horizontal size of the input data X, and C may represent a channel dimension (or a size of dimension) of the input data X.

Also, according to the inventive concept, original data being input is used as the query, and the key and the value are replaced with the spatially reduced data, and thus, the attention computation may be performed on the important information while further reducing the computation complexity.

In an embodiment, the self-attention block 424 may generate attention value data for the input data X, according to Equation 2 below. Here, as described above, the execution of the query embedding computation, the key embedding computation, and the value embedding computation may be skipped with respect to the input data X.

$$Q = X , K = V = SR ( X , R ) \\ Attention weight = softmax ( Q * {K}^{T} / \sqrt{{d}_{k}} ) \\ At ( X , R ) = Attention value = Attention weight * V \qquad [ Equation 2 ]$$

Here, Q represents a query, K represents a key, V represents a value, X represents input data, R represents a reduction ratio, SR(X, R) represents an execution result of a spatial reduction computation having the reduction ratio R with respect to the input data X, At(X, R) represents an execution result of the computation on the input data X of the attention block At including the spatial reduction block 422 having the reduction ratio R, Attention weight represents an attention weight, softmax represents a soft max computation, de represents a scaling factor, and Attention Value represents an attention value.

Referring back to FIG. 3 together with FIG. 4, according to Equation 3 below, the transformer block TB may process input data Xin and output output data Xout.

$$\begin{matrix}Z = At ( LN ( Xin ) , R ) + Xin \\ Xout = FFL ( LN ( Z ) ) + Z\end{matrix} \qquad [ Equation 3 ]$$

Here, Z represents, as an intermediate feature, an execution result of the first residual connection block Ad1, Xin represents input data of the transformer block TB, LN represents a normalization computation, At represents a computation of the attention block At including the spatial reduction block 422 having the reduction ratio R according to Equation 2, FFL represents a computation of the feed-forward network block FF according to Equation 1, and Xout represents output data of the transformer block TB.

That is, according to Equation 3, in the first sublayer of the transformer block TB, the execution result LN (Xin) of the normalization computation of the first layer normalization block N1 on the input data Xin is provided as the input data of the attention block At. Also, the first residual connection block Ad1 may perform an addition computation on the execution result At(LN(Xin), R) of the computation of the attention block At and the input data Xin, and thus, data of an intermediate feature Z may be generated. In the second sublayer of the transformer block TB, the execution result LN (Z) of the normalization computation of the second layer normalization block N2 on the intermediate feature Z is provided as input data to the feed-forward network block FF. Also, the second residual connection block Ad2 may perform an addition computation on the execution result FFL (LN (Z)) of the computation of the feed-forward network block FF and the data of the intermediate feature Z, and thus, the output data Xout may be generated.

FIG. 5 is a diagram illustrating a structure of a transformer model according to an example embodiment.

Referring to FIG. 5, the transformer model 300 may include first to fourth encoders 210-1 to 210-4, first to third decoders 220-1 to 220-3, and an MLP 230. Here, the first to fourth encoders 210-1 to 210-4 may correspond to the plurality of encoders 210 described with reference to FIG. 2, the first to third decoders 220-1 to 220-3 may correspond to the plurality of decoders 220 described with reference to FIG. 2, and the MLP 230 of FIG. 5 may correspond to the MLP 230 of FIG. 2. Repeated descriptions as those of FIG. 2 are omitted.

Referring to FIG. 5, the transformer block may further include an up-sampling block 240 and a concatenation block 250.

A transformer model 300 may generate output data OUTPUT DATA by processing input data INPUT DATA. Here, the input data INPUT DATA may include image data and represent an RGB value for each pixel of an image. Also, the output data OUTPUT DATA may include data predicted in units of pixels. For example, the output data OUPUT DATA may include a probability value for which class each pixel belongs to.

The first to fourth encoders 210-1 to 210-4 may transform image data into progressively higher-dimensional feature data. The first to third decoders 220-1 to 220-3 may generate feature data in which the feature data provided by the corresponding encoders has been transformed back into the lower dimension. Such a structure may be referred to as an encoder-decoder structure.

The first encoder 210-1 may include a transformer block TB_E_1 and a patch embedding block PE1. The patch embedding block PE1 may perform patch embedding on the input data INPUT DATA to generate first patch data, which is an execution result of a computation of the patch embedding block PE1. Here, the first patch data may include data in which a plurality of patch tokens have been transformed into a single vector. Also, the patch embedding block PE1 may provide the first patch data to the transformer block TB_E_1. The transformer block TB_E_1 may extract a feature for the first patch data on the basis of attention value data that is an execution result of an attention block in the transformer block TB_E_1, thereby generating first feature data. The transformer block TB_E_1 may provide the first feature data to the second encoder 210-2.

The second encoder 210-2 may include a transformer block TB_E_2 and a patch embedding block PE2. The patch embedding block PE2 may perform patch embedding on the first feature data to generate second patch data, which is an execution result of a computation of the patch embedding block PE2. Here, unlike the first patch data, the second patch data may not be patch data for image data, but may include patch data for the first feature data in a higher dimension. Also, the patch embedding block PE2 may provide the second patch data to the transformer block TB_E_2. The transformer block TB_E_2 may extract a feature for the second patch data on the basis of attention value data that is an execution result of an attention block in the transformer block TB_E_2, thereby generating second feature data. Accordingly, the second encoder 210-2 may generate the second feature data in a higher dimension on the basis of the first feature data of the first encoder 210-1. The transformer block TB_E_2 may provide the second feature data to the third encoder 210-3. Also, the transformer block TB_E_2 may provide the second feature data to the first decoder 220-1 corresponding to the second encoder 210-2.

The third encoder 210-3 may include a transformer block TB_E_3 and a patch embedding block PE3. The patch embedding block PE3 may perform patch embedding on the second feature data to generate third patch data, which is an execution result of a computation of the patch embedding block PE3. Here, the third patch data may include patch data for the second feature data, which is in a higher dimension than the second patch data. Also, the patch embedding block PE3 may provide the third patch data to the transformer block TB_E_3. The transformer block TB_E_3 may extract a feature for the third patch data on the basis of attention value data that is an execution result of an attention block in the transformer block TB_E_3, thereby generating third feature data. Accordingly, the third encoder 210-3 may generate the third feature data in a higher dimension on the basis of the second feature data of the second encoder 210-2. The transformer block TB_E_3 may provide the third feature data to the fourth encoder 210-4. Also, the transformer block TB_E_3 may provide third feature data to the second decoder 220-2 corresponding to the third encoder 210-3.

The fourth encoder 210-4 may include a transformer block TB_E_4 and a patch embedding block PE4. The patch embedding block PE4 may perform patch embedding on the third feature data to generate fourth patch data, which is an execution result of a computation of the patch embedding block PE4. Here, the fourth patch data may include patch data for the third feature data, which is in a higher dimension than the third patch data. Also, the patch embedding block PE4 may provide the fourth patch data to the transformer block TB_E_4. The transformer block TB_E_4 may extract a feature for the fourth patch data on the basis of attention value data that is an execution result of an attention block in the transformer block TB_E_4, thereby generating fourth feature data. Accordingly, the fourth encoder 210-4 may generate the fourth feature data in a higher dimension on the basis of the third feature data of the third encoder 210-3. The transformer block TB_E_4 may provide the fourth feature data to the third decoder 220-3 corresponding to the fourth encoder 210-4.

The first decoder 220-1 may include a transformer block TB_D_1. The first decoder 220-1 may be provided with the second feature data from the second encoder 210-2 corresponding thereto. The first decoder 220-1 may extract a feature for the second feature data on the basis of a computation of the transformer block TB_D_1, thereby generating fifth feature data.

The second decoder 220-2 may include a transformer block TB_D_2_1 and a transformer block TB_D_2_2. The second decoder 220-2 may be provided with the third feature data from the third encoder 210-3 corresponding thereto. The second decoder 220-2 may extract a feature for the third feature data on the basis of computations of the transformer block TB_D_2_1 and the transformer block TB_D_2_2, thereby generating sixth feature data. Referring to FIG. 5, in the second decoder 220-2, the transformer block TB_D_2_1 performs a computation on the third feature data and the transformer block TB_D_2_2 performs a computation on the execution result of the computation of the transformer block TB_D_2_1. Accordingly, the sixth feature data may be generated.

The third decoder 220-3 may include a transformer block TB_D_3_1, a transformer block TB_D_3_2, and a transformer block TB_D_3_3. The third decoder 220-3 may be provided with the fourth feature data from the fourth encoder 210-4 corresponding thereto. The third decoder 220-3 may extract a feature for the fourth feature data on the basis of computations of the transformer block TB_D_3_1, the transformer block TB_D_3_2, and the transformer block TB_D_3_3, thereby generating seventh feature data. Referring to FIG. 5, in the third decoder 220-3, the transformer block TB_D_3_1 performs a computation on the fourth feature data, the transformer block TB_D_3_2 performs a computation on the execution result of the computation of the transformer block TB_D_3_1, and the transformer block TB_D_3_3 performs a computation on the execution result of the computation of the transformer block TB_D_3_2. Accordingly, the seventh feature data may be generated.

In an embodiment, the number of transformer blocks in each of the plurality of decoders 220 described with reference to FIG. 2 may vary. For example, referring to FIG. 5, the first decoder 220-1 may include one transformer block TB_D_1, the second decoder 220-2 may include two transformer blocks TB_D_2_1 and TB_D_2_2, and the third decoder 220-3 may include three transformer blocks TB_D_3_1, TB_D_3_2, and TB_D_3_3. Here, the two transformer blocks TB_D_2_1 and TB_D_2_2 may be connected to each other and the three transformer blocks TB_D_3_1, TB_D_3_2, and TB_D_3_3 may be connected to each other. That is, an execution result of a previous transformer block may be provided to a next transformer block.

In embodiments, referring to FIGS. 2 and 5, as the number of patch embedding operations performed on data input to any one decoder among the plurality of decoders 220 increases, the number of transformer blocks in any one decoder may increase. The number of patch embedding operations performed on the second feature data of the second encoder 210-2, which is input to the first decoder 220-1, may be a total of two (e.g., patch embedding operations performed by patch embedding blocks PE1 and PE2), the number of patch embedding operations performed on the second feature data of the second encoder 210-2, which is input to the second decoder 220-2, may be a total of three (e.g., patch embedding operations performed by patch embedding blocks PE1, PE2, and PE3), and the number of patch embedding operations performed on the second feature data of the second encoder 210-2, which is input to the third decoder 220-3, may be a total of four (e.g., patch embedding operations performed by patch embedding blocks PE1, PE2, PE3, and PE4). Accordingly, referring to FIG. 5, the first decoder 220-1 may include the one transformer block TB_D_1, the second decoder 220-2 may include the two transformer blocks TB_D_2_1 and TB_D_2_2, and the third decoder 220-3 may include the three transformer blocks TB_D_3_1, TB_D_3_2, and TB_D_3_3. This is because as more patch embedding operations are performed, the dimensions of data in the output feature are reduced, so the required computation quantity is reduced. Therefore, the computations of more transformer blocks may be performed on feature data on which more patch embedding operations have been performed. That is, as the dimensions of the feature data input to the decoder are reduced, more transformer blocks may be applied. Accordingly, more transformer blocks may be used for the reduced data to perform elaborate computations and efficient data processing.

The up-sampling block 240 may perform an up-sampling computation on each of the sixth feature data of the second decoder 220-2 and the seventh feature data of the third decoder 220-3 so that the dimension size of the sixth feature data of the second decoder 220-2 and the dimension size of the seventh feature data of the third decoder 220-3 are the same as the dimension size of the fifth feature data of the first decoder 220-1. That is, the up-sampling block 240 increases the dimension sizes of the sixth feature data and the seventh feature data to the same dimension as the fifth feature data, and thus, the dimension size of each feature data in subsequent computations may be consistent.

The concatenation block 250 may perform concatenation computations on the fifth feature data and the sixth and seventh feature data in which the dimension sizes have increased, thereby providing concatenated data to the MLP 230.

The MLP 230 may process the concatenated data and output the output data OUPUT DATA.

In an embodiment, when the transformer model 300 is trained, in order for the MLP 230 to output the target data (e.g., output data OUPUT DATA) for a given input (e.g., input data INPUT DATA), convolution-based parameters associated with the patch embedding blocks PE1 to PE4, parameters associated with the feed-forward network blocks of the transformer blocks TB_E_1 to TB_E_4 in the first to fourth encoders 210-1 to 210-4, parameters associated with the feed-forward network blocks of the transformer blocks TB_D_1 and TB_D_2_1 to TB_D_3_3 in the first to third decoders 220-1 to 220-3, and parameters associated with the MLP 230 may be updated.

In an embodiment, when inference is performed by using the pre-trained transformer model 300, in order for the MLP 230 to output the target data for a given input, pre-trained parameters may include convolution-based parameters associated with the patch embedding blocks PE1 to PE4, parameters associated with the feed-forward network blocks of the transformer blocks TB_E_1 to TB_E_4 in the first to fourth encoders 210-1 to 210-4, parameters associated with the feed-forward network blocks of the transformer blocks TB_D_1 and TB_D_2_1 to TB_D_3_3 in the first to third decoders 220-1 to 220-3, and parameters associated with the MLP 230.

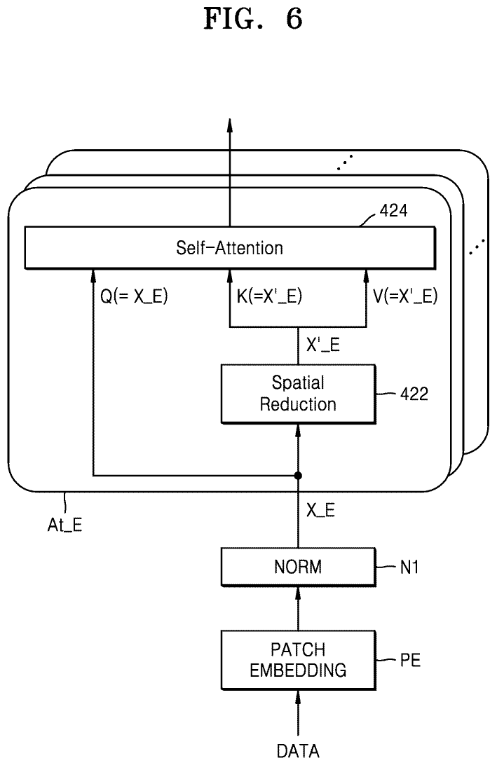

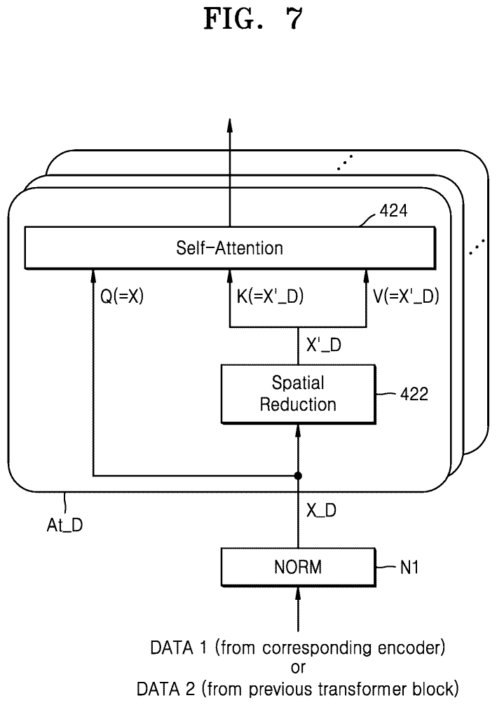

According to the inventive concept, the execution of the key embedding computation, the execution of the query embedding computation, and/or the execution of the value embedding computation may be skipped with respect to the input data of the transformer blocks TB_E_1 to TB_E_4 included respectively in the first to fourth encoders 210-1 to 210-4. The execution of the key embedding computation, the execution of the query embedding computation, and/or the execution of the value embedding computation may be skipped with respect to the input data of the transformer blocks TB_D_1 and TB_D_2_1 to TB_D_3_3 included in the first to third decoders 220-1 to 220-3. This is described in detail with reference to FIGS. 6 and 7.

FIG. 6 is a diagram illustrating a processing operation in an attention block of an encoder, according to an example embodiment. FIG. 7 is a diagram illustrating a processing operation in an attention block of a decoder, according to an example embodiment. The attention blocks in the transformer blocks TB_E_1 to TB_E_4 of the first to fourth encoders 210-1 to 210-4 described with reference to FIG. 5 may correspond to the attention blocks At described with reference to FIG. 4. FIG. 6 is a diagram illustrating an attention block At_E, which is one of the attention blocks of the transformer blocks TB_E_1 to TB_E_4 described with reference to FIG. 5. The attention blocks in the transformer blocks TB_D_1 and TB_D_2_1 to TB_D_3_3 of the first to third decoders 220-1 to 220-3 described with reference to FIG. 5 may correspond to the attention blocks At described with reference to FIG. 4. FIG. 7 is a diagram illustrating an attention block At_D, which is one of the attention blocks of the transformer blocks TB_D_1 and TB_D_2_1 to TB_D_3_3 described with reference to FIG. 5. Repeated descriptions as those given with reference to FIGS. 2 to 5 are omitted.

The processing operations performed in the attention block At_E and the attention block At_D may be performed by the processor 110 of FIG. 1.

Referring to FIGS. 1, 3, 4, and 6, in a patch embedding block PE of one of the encoders, the processor 110 may perform a patch embedding computation on input data DATA, thereby generating patch data PATCH DATA. In the first layer normalization block N1 of one of the encoders, the processor 110 may perform a normalization computation on the patch data PATCH DATA, which is a result of the patch embedding block PE, thereby generating normalized patch data X_E. In the attention block At_E of one of the encoders, the processor 110 may use the normalized patch data X_E as a query and use a result X′_E, which is a result of executing a spatial reduction computation on the normalized patch data X_E, as a key and a value, thereby generating attention value data for the patch data X_E. Here, the processor 110 may perform the spatial reduction computation on the normalized patch data X_E in the spatial reduction block 422 and may generate the attention value data for the patch data X_E in the self-attention block 424.

Referring to FIGS. 1, 3, 4, and 7, in the first layer normalization block N1 of one of the decoders, the processor 110 may perform a normalization computation on first data DATA 1 generated from the encoder corresponding to the decoder or second data DATA 2 generated from the previous transformer block, thereby generating normalized data X_D. For example, when one decoder corresponds to the second decoder 220-2 of FIG. 5, the first data DATA 1 in the first layer normalization block N1 of the transformer block TB_D_2_1 may represent the third feature data of the corresponding encoder, which is the third encoder 210-3, and the second data DATA 2 in the first layer normalization block N1 of the transformer block TB_D_2_2 may represent an output feature of the previous transformer block, which is the transformer block TB_D_2_1. In the attention block At_D of one of the decoders, the processor 110 may use the normalized data X_D as a query and a result X′_D, which is a result of executing a spatial reduction computation on the normalized data X_D, as a key and a value, thereby generating attention value data for the first data DATA 1 or the second data DATA 2. Here, the processor 110 may perform the spatial reduction computation on the normalized data X_D in the spatial reduction block 422 and may generate the attention value data for the first data DATA 1 or the second data DATA 2 in the self-attention block 424.

That is, in the attention block At_E of one of the encoders and/or the attention block At_D of one of the decoders, the processor 110 may skip key embedding, query embedding, and/or value embedding with respect to the input data.

FIG. 8 is a diagram illustrating training and inference of the transformer model described with reference to FIG. 5. The transformer model 300 described with reference to FIG. 5 may correspond to a training transformer model 400 of FIG. 8 and a pre-trained transformer model 500 of FIG. 8.

Referring to FIG. 8, it can be seen that reduction ratios

$$[ {t}_{E}^{1} , {t}_{E}^{2} , {t}_{E}^{3} , {t}_{E}^{4} ] and [ {t}_{D}^{1} , {t}_{D}^{2} , {t}_{D}^{3} ]$$

are applied to the spatial reduction computation of each transformer block in the training transformer model 400, and reduction ratios

$$[ {r}_{E}^{1} , {r}_{E}^{2} , {r}_{E}^{3} , {r}_{E}^{4} ] and [ {r}_{D}^{1} , {r}_{D}^{2} , {r}_{D}^{3} ]$$

are applied to the spatial reduction computation of each transformer block in the pre-trained transformer model 500.

Here, the reduction ratios

$$[ {t}_{E}^{1} , {t}_{E}^{2} , {t}_{E}^{3} , {t}_{E}^{4} ] and [ {r}_{E}^{1} , {r}_{E}^{2} , {r}_{E}^{3} , {r}_{E}^{4} ]$$

may represent the reduction ratios applied to an encoding stage, and the reduction ratios

$$[ {t}_{D}^{1} , {t}_{D}^{2} , {t}_{D}^{3} ] and [ {r}_{D}^{1} , {r}_{D}^{2} , {r}_{D}^{3} ]$$

may represent the reduction ratios applied to a decoding stage. For example, the reduction ratios

$$[ {t}_{E}^{1} , {t}_{E}^{2} , {t}_{E}^{3} , {t}_{E}^{4} ]$$

may represent sequentially the reduction ratios applied to the spatial reduction computations of the transformer blocks in the first to fourth encoders 210-1 to 210-4 of FIG. 5, which are being trained, respectively.

For example, when the reduction ratio is 2, as each of the height dimension H and the width dimension W is reduced by half, the size of the execution result data in the computation may be H/2*W/2. When the reduction ratio is 4, as each of the height dimension H and the width dimension W is reduced by ¼, the size of the execution result data in the computation may be H/4*W/4. When the reduction ratio is 8, as each of the height dimension H and the width dimension W is reduced by ⅛, the size of the execution result data in the computation may be H/8*W/8. That is, as the reduction ratio increases, the size of the data decreases significantly.

In an embodiment, at least one of the reduction ratios applied to the spatial reduction computation of the transformer blocks of the training transformer model 400 may be different from at least one corresponding reduction ratio of the pre-trained transformer model 500.

For example, when the processor 110 trains the transformer model 400, a first spatial reduction computation having a first reduction ratio

$$( e . g . , {t}_{E}^{1} )$$

may be performed on the normalized patch data in an attention block of one of the encoders (e.g., a first encoder). Also, when the processor 110 performs inference by using the pre-trained transformer model 500, a second spatial reduction computation having a second reduction ratio

$$( e . g . , {r}_{E}^{1} )$$

may be performed on the normalized patch data in an attention block of the same encoder (e.g., the first encoder). Here, the first reduction ratio

$$( e . g . , {t}_{E}^{1} )$$

may be different from the second reduction ratio

$$( e . g . , {r}_{E}^{1} ) .$$

Also, in an embodiment herein, the second reduction ratio

$$( e . g . , {r}_{E}^{1} )$$

in the case of performing inference may be greater than the first reduction ratio

$$( e . g . , {t}_{E}^{1} )$$

in the case of training. That is, some of the reduction ratios applied to the spatial reduction computations of respective transformer blocks of the pre-trained transformer model 500 may be greater than the corresponding reduction ratios of the training transformer model 400. Accordingly, when performing inference of the pre-trained transformer model 500, the computation complexity may be further reduced.

Even if the dimension size of the value and key data is reduced, the dimension size of the data input to the attention block and the dimension size of the data output therefrom may be maintained. Therefore, the computation complexity may be reduced while not significantly degrading the inference performance of the pre-trained transformer model 500.

In an embodiment, the reduction ratios

$$[ {r}_{E}^{1} , {r}_{E}^{2} , {r}_{E}^{3} , {r}_{E}^{4} ] and [ {r}_{D}^{1} , {r}_{D}^{2} , {r}_{D}^{3} ]$$

respectively applied to the spatial reduction computations of the transformer blocks of the pre-trained transformer model 500 may be adjusted based on a user's selection.

FIG. 9 is a diagram illustrating the computation quantity and performance evaluation of the transformer model of FIG. 5 according to a reduction ratio applied during training and a reduction ratio applied during inference.

Referring to FIGS. 8 and 9, there is a table showing giga floating point operations (GFLOPs), which are indexes of the computation quantities, and a mean intersection over union (mIoU), which is an index of the performance evaluation, based on the reduction ratio applied to the training transformer model 400 and the reduction ratio applied to the inference of the pre-trained transformer model 500. The table above shows comparison execution results in a transformer model having 4.9M parameters and a transformer model having 29.4M parameters, depending on the size of parameters. Here, ADE20K, Cityscapes, and COCO-Stuff represent datasets for evaluating the performance of the transformer model.

Referring to FIGS. 8 and 9, in the case in which the reduction ratios

$$[ {t}_{E}^{1} , {t}_{E}^{2} , {t}_{E}^{3} , {t}_{E}^{4} ] and [ {t}_{D}^{1} , {t}_{D}^{2} , {t}_{D}^{3} ]$$

applied to the training transformer model 400 are [8, 4, 2, 1]-[1, 2, 4], when the reduction rations

$$[ {r}_{E}^{1} , {r}_{E}^{2} , {r}_{E}^{3} , {r}_{E}^{4} ] [ {r}_{D}^{1} , {r}_{D}^{2} , {r}_{D}^{3} ]$$

applied to the inference of the pre-trained transformer model 500 are [16, 8, 2, 1]-[2, 4, 8], it can be seen that the GFLOPs are significantly reduced while the mIoU is maintained. That is, in inference compared to training, when the reduction ratios applied to the first encoder 210-1 and the second encoder 210-2 of FIG. 5 and the reduction ratios applied to the first to third decoders 220-1 to 220-3 are doubled, high performance (mIoU) may be achieved relative to low computation quantities (GFLOPs).

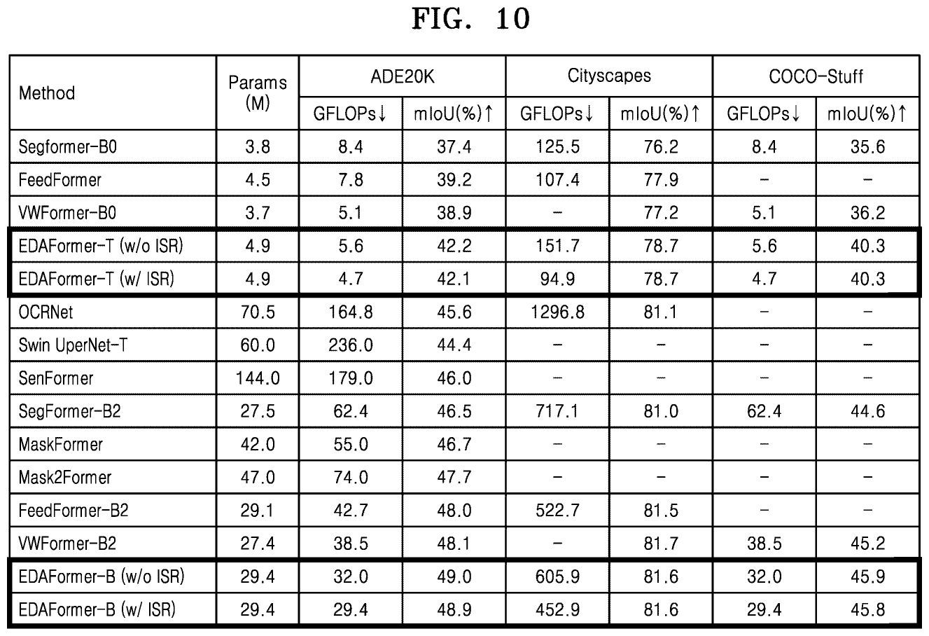

FIG. 10 is a diagram illustrating the computation quantity and performance evaluation of the transformer model of FIG. 5.

Referring to FIGS. 5 and 10, there is a table showing GFLOPS, which are indexes of the computation quantities, and mIoU, which is an index of the performance evaluation, in the transformer model 300 proposed herein, compared to other transformer models according to the related art. In FIG. 10, the transformer model 300 may be referred to as an EDAFormer. Also, depending on the size of parameters, a transformer model having 4.9M parameters may be referred to as an EDAForer-T, and a transformer model having 29.4M parameters may be referred to as an EDAFormer-B. Here, ADE20K, Cityscapes, and COCO-Stuff represent datasets for evaluating the performance of the transformer model 300.

According to the inventive concept, in the attention block At proposed in FIG. 4, the computations of the query embedding block 412 according to the comparative example, the key embedding block 414 according to the comparative example, and the value embedding block 416 according to the comparative example are skipped with respect to the data X input to the attention block At. Accordingly, the computation quantities of the query embedding block 412, the key embedding block 414, and the value embedding block 416 may be reduced, thereby reducing the computation complexity.

Also, according to the inventive concept, original data being input is used as the query, and the key and the value are replaced with the spatially reduced data, and thus, the attention computation may be performed on the important information while further reducing the computation complexity.

Referring to FIGS. 4, 5, and 10, it can be seen that GFLOPS and mIoUs of the transformer model 300 are shown depending on whether or not a spatial reduction computation is performed (w/o Inference Spatial Reduction (ISR) and w/ISR). The executions of the computations of the key embedding block 414 and the value embedding block 416 in the comparative example are skipped in the transformer model 300, the original data being input is used as the query, and the key and the value are replaced with the spatially reduced data. Therefore, the transformer model 300 may achieve high performance (mIoU) relative to low computation quantities (GFLOPs).

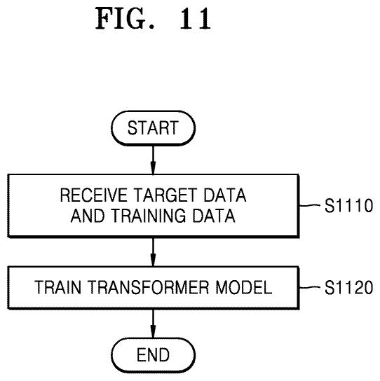

FIG. 11 is a flowchart illustrating operations in a method of training the transformer model of FIG. 3. The operations in the method of training the transformer model may be performed by the electronic device 100 of FIG. 1.

The transformer model may include a plurality of encoders and a plurality of decoders. Each of the plurality of encoders may include a patch embedding block and an attention block.

In operation S1110, an electronic device receives target data and training data. The training data may include image data, and the target data may include labeling data and represent a probability value for which class each pixel belongs to with respect to the training data.

In operation S1120, the electronic device may train the transformer model to output the target data with respect to the training data.

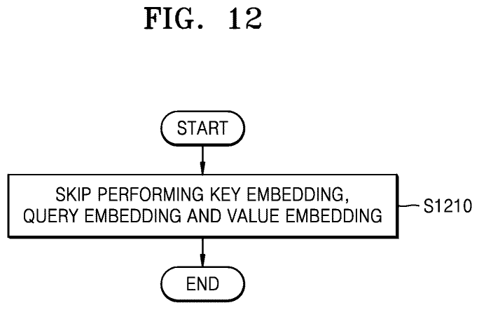

FIG. 12 is a flowchart illustrating an operation of any one attention block in the transformer model in operation S1120 of FIG. 11.

In operation S1210, performing the key embedding computation, performing the query embedding computation, and performing the value embedding computation on the input data of the attention block may be skipped.

For example, in the attention block of the encoder, patch embedding may be performed on the data that is input to a patch embedding block. A normalization computation may be performed on the result of the patch embedding block. Performing the key embedding computation, performing the query embedding computation, or performing the value embedding computation on the normalized patch data in the attention block may be skipped. A spatial reduction computation may be performed on the normalized patch data. In the attention block, the normalized patch data is used as a query, and the execution result of the spatial reduction computation on the normalized patch data is used as a key and a value. Accordingly, the attention value data for the patch data may be generated.

For example, in the attention block of the decoder, the normalization computation may be performed on the input data. Performing the key embedding computation, performing the query embedding computation, or performing the value embedding computation on the normalized data in the attention block may be skipped. A spatial reduction computation may be performed on the normalized data. In the attention block, the normalized data is used as a query, and the execution result of the spatial reduction computation on the normalized data is used as a key and a value. Accordingly, the attention value data for the data may be generated.

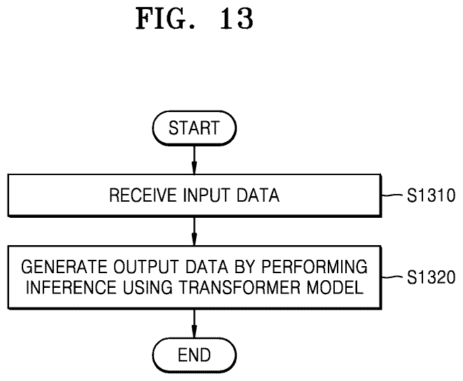

FIG. 13 is a flowchart illustrating operations in a method of performing inference by using the transformer model of FIG. 3. The operations in the method of performing the inference may be performed by the electronic device 100 of FIG. 1.

A pre-trained transformer model may include a plurality of encoders and a plurality of decoders. Each of the plurality of encoders may include a patch embedding block and an attention block.

In operation S1310, an electronic device may receive input data. The input data may include image data.

In operation S1320, the electronic device may use the transformer model to perform inference on the input data, thereby generating the output data. The output data may include prediction data and represent a probability value for which class each pixel belongs to with respect to the input data.

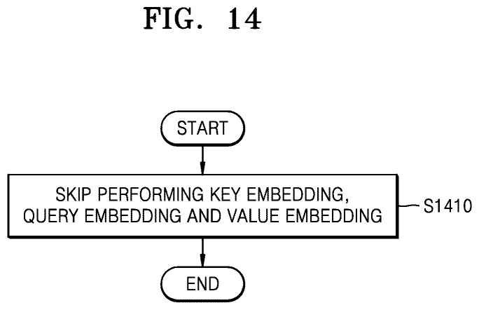

FIG. 14 is a flowchart illustrating an operation of any one attention block in the pre-trained transformer model in operation S1320 of FIG. 13.

In operation S1410, performing the key embedding computation, performing the query embedding computation, and performing the value embedding computation on the input data of the attention block may be skipped.

For example, in the attention block of the encoder, patch embedding may be performed on the data that is input to a patch embedding block. A normalization computation may be performed on the result of the patch embedding block. Performing the key embedding computation, performing the query embedding computation, or performing the value embedding computation on the normalized patch data in the attention block may be skipped. A spatial reduction computation may be performed on the normalized patch data. In the attention block, the normalized patch data is used as a query, and the execution result of the spatial reduction computation on the normalized patch data is used as a key and a value. Accordingly, the attention value data for the patch data may be generated.

For example, in the attention block of the decoder, the normalization computation may be performed on the input data. Performing the key embedding computation, performing the query embedding computation, or performing the value embedding computation on the normalized data in the attention block may be skipped. A spatial reduction computation may be performed on the normalized data. In the attention block, the normalized data is used as a query, and the execution result of the spatial reduction computation on the normalized data is used as a key and a value. Accordingly, the attention value data for the data may be generated.

The embodiments described above may be implemented as hardware components, software components, and/or combinations of the hardware components and the software components. For example, the devices, methods, and components described in the embodiments may be implemented by using a general-purpose computer or a special-purpose computer, such as, a processor, a controller, an arithmetic logic unit (ALU), a DSP, a microcomputer, an FPGA, a programmable logic unit (PLU), a microprocessor, or any other device capable of executing an instruction and responding to the instruction. A processing device may execute an operating system (OS) and software applications performed on the OS. The processing device may also access, store, manipulate, process, and generate data in response to the execution of the software. For convenience of understanding, the processing device is sometimes described as utilizing a single processing unit, but a person skilled in the art may appreciate that the processing device may include a plurality of processing elements and/or a plurality of types of processing elements. For example, the processing device may include a plurality of processors or one processor and one controller. In addition, other processing configurations are also possible, such as parallel processors.

The software may include computer programs, code, instructions, or one or more combinations thereof, and may configure a processing device so that the processing device operates as desired, or may independently or collectively instruct the processing device. In order to perform interpretation by using a processing device or to provide instructions or data to a processing device, the software and/or data may be permanently or temporarily embodied in any type of a machine, a component, physical equipment, virtual equipment, a computer storage medium, or a device. The software may be distributed on networked computer systems and stored or executed in a distributed manner. The software and data may be stored in a computer-readable recording medium.

The method according to an embodiment may be implemented in the form of program instructions that may be executed by various computer means and recorded in a computer-readable medium. The computer-readable medium may store program instructions, data files, data structures, and the like, in individual or combination manners, and the program instructions recorded in the medium may be specifically designed and configured for the embodiment or may be known and available to those skilled in the art of computer software. Examples of the computer-readable recording media include magnetic media, such as hard disks, floppy disks, and magnetic tapes, optical media, such as compact disk read only memory (CD-ROM) and digital versatile disks (DVD), and magneto-optical media, such as floptical disks, and hardware devices, specifically configured to store and execute program instructions, such as ROM, RAM, and flash memory. Examples of the program instructions include machine language code, such as that created by a compiler, and high-level language code that may be executed by a computer using an interpreter or the like.

The hardware devices described above may be configured to operate as one or more software modules to perform the operations of the embodiments, and vice versa.

Although embodiments have been described with reference to the limited drawings, a person skilled in the art may make various technical modifications and variations on the basis of the embodiments. For example, suitable results may be obtained even if the described techniques are performed in a different order than in the described methods, and/or the components of the described systems, structures, devices, circuits, etc. are coupled or combined to each other in a different form than in the described methods, or substituted or replaced with other components or equivalents.

While the inventive concept has been particularly shown and described with reference to embodiments thereof, it will be understood that various changes in form and details may be made therein without departing from the spirit and scope of the following claims.

What is claimed is:

1. An electronic device comprising:
a processor configured to train a transformer model comprising a plurality of encoders and a plurality of decoders, or configured to perform inference by using a pre-trained transformer model; and
memory configured to store instructions executed by the processor,
wherein each of the plurality of encoders comprises a patch embedding block configured to perform patch embedding on input data and a first attention block configured to generate attention value data, and
wherein when the instructions are executed by the processor, the processor is configured to:
perform a normalization computation on patch data, which is a result by the patch embedding block, to thereby generate normalized patch data; and
use the normalized patch data as a query and a result of performing a spatial reduction computation on the normalized patch data as a key and a value in the first attention block, to thereby generate attention value data with respect to the patch data.

2. The electronic device of claim 1,
wherein each of the plurality of decoders comprises at least one transformer block,
wherein each of the transformer blocks comprises a second attention block configured to generate attention value data, and
wherein the processor is configured to:
perform a normalization computation on first data generated from an encoder of the plurality of encoders corresponding to each of the plurality of decoders or second data generated from a previous transformer block, to thereby generate normalized data; and
use the normalized data as a query and a result of performing a spatial reduction computation on the normalized data as a key and a value in the second attention block, to thereby generate attention value data with respect to the first data or the second data.

3. The electronic device of claim 1, wherein the processor is configured to skip, in the first attention block, one or more of key embedding, query embedding, and value embedding with respect to data input to the first attention block.

4. The electronic device of claim 2, wherein the processor is configured to skip, in the second attention block, one or more of key embedding, query embedding, and value embedding with respect to data input to the second attention block.

5. The electronic device of claim 2, wherein numbers of the transformer blocks in the plurality of decoders are different from each other.

6. The electronic device of claim 2, wherein, as a number of executions of the patch embedding performed on data input to a first decoder among the plurality of decoders increases, a number of the transformer blocks in the first decoder increases.

7. The electronic device of claim 1, wherein the processor is configured to:
perform first spatial reduction computation having a first reduction ratio on the normalized patch data, in a first attention block of a first encoder, when training the transformer model; and
perform second spatial reduction computation having a second reduction ratio on the normalized patch data, in the first attention block of the first encoder, when performing inference by using the pre-trained transformer model,
wherein the first reduction ratio is different from the second reduction ratio.

8. The electronic device of claim 7, wherein the second reduction ratio is greater than the first reduction ratio.

9. A method of training a transformer model comprising a plurality of encoders and a plurality of decoders, wherein each of the plurality of encoders and the plurality of decoders comprises a transformer block comprising an attention block, and the method is performed by an electronic device and comprises:
receiving target data and training data; and
training the transformer model to output the target data with respect to the training data,
wherein the training of the transformer model comprises skipping performing one or more of a key embedding computation, a query embedding computation, and a value embedding computation on input data of the attention block.

10. The method of claim 9,
wherein each of the plurality of encoders comprises a patch embedding block configured to perform patch embedding on input data and a first attention block configured to generate attention value data, and
wherein the training of the transformer model comprises:
performing a normalization computation on patch data, which is a result by the patch embedding block, to thereby generate normalized patch data;
performing a spatial reduction computation on the normalized patch data; and
using the normalized patch data as a query and a result of performing a spatial reduction computation on the normalized patch data as a key and a value in the first attention block, to thereby generate attention value data with respect to the patch data.

11. The method of claim 9,
wherein each of the plurality of decoders comprises at least one transformer block,
wherein each of the transformer blocks comprises a second attention block configured to generate attention value data, and
wherein the training of the transformer model comprises:
performing a normalization computation on first data generated from an encoder of the plurality of encoders corresponding to each of the plurality of decoders or second data generated from a previous transformer block, to thereby generate normalized data;
performing a spatial reduction computation on the normalized data; and
using the normalized data as a query and a result of performing a spatial reduction computation on the normalized data as a key and a value in the second attention block, to thereby generate attention value data with respect to the first data or the second data.

12. The method of claim 11, wherein numbers of the transformer blocks in the plurality of decoders are different from each other.

13. The method of claim 11, wherein, as a number of executions of patch embedding performed on data input to a first decoder among the plurality of decoders increases, a number of the transformer blocks in the first decoder increases.

14. A method of performing inference by using a transformer model comprising a plurality of encoders and a plurality of decoders, wherein each of the plurality of encoders and the plurality of decoders comprises a transformer block comprising an attention block, and the method is performed by an electronic device and comprises:
receiving input data; and
using the transformer model to perform inference on the input data, thereby generating output data,
wherein the generating of the output data comprises skipping performing one or more of a key embedding computation, a query embedding computation, and a value embedding computation on input data of the attention block.

15. The method of claim 14,
wherein each of the plurality of encoders comprises a patch embedding block configured to perform patch embedding on the input data and a first attention block configured to generate attention value data, and
wherein the generating of the output data comprises:
performing a normalization computation on patch data, which is a result by the patch embedding block, to thereby generate normalized patch data;
performing a spatial reduction computation on the normalized patch data; and
using the normalized patch data as a query and a result of performing a spatial reduction computation on the normalized patch data as a key and a value in the first attention block, to thereby generate attention value data with respect to the patch data.

16. The method of claim 14,
wherein each of the plurality of decoders comprises at least one transformer block, each of the transformer blocks comprises a second attention block configured to generate attention value data, and
wherein the generating of the output data comprises:
performing a normalization computation on first data generated from an encoder of the plurality of encoders corresponding to each of the plurality of decoders or second data generated from a previous transformer block, to thereby generate normalized data;
performing a spatial reduction computation on the normalized data; and
using the normalized data as a query and a result of performing a spatial reduction computation on the normalized data as a key and a value in the second attention block, to thereby generate attention value data with respect to the first data or the second data.

17. The method of claim 16, wherein numbers of the transformer blocks in the plurality of decoders are different from each other.

18. The method of claim 16, wherein, as a number of executions of patch embedding performed on data input to a first decoder among the plurality of decoders increases, a number of the transformer blocks in the first decoder increases.

19. The method of claim 15, further comprising:
performing first spatial reduction computation having a first reduction ratio on first normalized patch data in the first attention block, to thereby pre-train the transformer model,
wherein the generating of the output data further comprises performing second spatial reduction computation having a second reduction ratio on second normalized patch data in the first attention block, to thereby perform inference by using the transformer model, and
wherein the first reduction ratio is different from the second reduction ratio.

20. The method of claim 19, wherein the second reduction ratio is greater than the first reduction ratio.
